(19) United States
(12) Patent Application Publication
(10) Pub. No.: US 2010/0086024 A1
(43) Pub. Date: Apr. 8, 2010

(54) STREAMING SCALABLE VIDEO OVER FADING WIRELESS CHANNELS

(75) Inventors: HONGHAI ZHANG, Ewing, NJ (US); Mohammad A. KHOJASTEPOUR, North Brunswick, NJ (US)

Correspondence Address: NEC LABORATORIES AMERICA, INC., 4 INDEPENDENCE WAY, Suite 200, PRINCETON, NJ, 08540, US

(73) Assignee: NEC Laboratories America, Inc., Princeton, NJ (US)

(21) Appl. No.: 12/509,586

(22) Filed: Jul. 27, 2009

Related U.S. Application Data
(60) Provisional application No. 61/102,092, filed on Oct. 2, 2008.
(60) Provisional application No. 61/117,652, filed on Nov. 25, 2008.

(51) Int. Cl. H04N 7/24

(52) U.S. Cl. 375/240.02; 375/E07.003

(57) ABSTRACT

A method and apparatus are provided for streaming scalable video over fading wireless channels. The method includes building a model relating to a relationship between an average data rate and an average peak signal-to-noise ratio for a video sequence encoded using scalable video coding and having a base layer and one or more enhancement layers. The method also includes computing a vector relating to a set of average data rates for a particular boundary point on an achievable rate region for a transmission strategy. The boundary point is a function of a parameter set for a plurality of users. The achievable rate region is based upon the model. The method further includes scheduling the plurality of users to receive the video sequence over a wireless channel, such that at a given transmission time slot a particular one of the plurality of users associated with a maximum value is selected. The maximum value is based on the vector and a channel capacity available to the particular one of the plurality of users.

### RELATED APPLICATION INFORMATION

This application claims priority to provisional application Ser. No. 61/102,092 filed on Oct. 2, 2008, and provisional application Ser. No. 61/117,652 filed on Nov. 25, 2008, both of which are incorporated herein by reference.

### BACKGROUND

1. Technical Field

The present invention relates to mobile communications, and more particularly to streaming scalable video over fading wireless channels.

2. Description of the Related Art

Wireless video streaming is becoming increasingly popular as both wireless networking and video coding technologies have made significant progress. On the wireless side, the data transmission rates are steadily growing. Latest WiFi networks can support data rate of more than 100 Mbps and the next generation (4G) wireless technologies are expected to achieve 1 Gbps for nomadic users and 100 Mbps for mobile users. On the video coding side, the International Organization for Standardization/International Electro technical Commission (ISO/IEC) Moving Picture Experts Group-4 (MPEG-4) Part 10 Advanced Video Coding (AVC) standard/International Telecommunication Union, Telecommunication Sector (ITU-T) H.264 Recommendation (hereinafter the “MPEG-4 AVC Standard”) enables more efficient video compression and the scalable video coding (SVC) extension of the MPEG-4 AVC Standard allows more flexible video coding. Nevertheless, it remains a challenge to adapt wireless networks to satisfy the requirements of video streaming services. In fading wireless networks, most MAC schedulers employ some type of channel-state aware scheduling algorithms (e.g., Proportional Fair Scheduling) to exploit multi-user diversity. However these schemes often ignore the real-time quality of service (QoS) requirement of video traffic.

Moreover, since the wireless medium is often shared by many users, it is desirable to adapt to the wireless channel conditions in order to satisfy stringent bandwidth and delay requirement of video traffic. Streaming video over wireless networks has been studied extensively by many researchers, but much of the previous work has focused on the single-stream scenario where the transmitter of a video streaming service adaptively adjusts its transmission rate, re-transmission, video-truncation, forward error correction (FEC) and/or HARQ policy in order to optimize the received video quality. However, the wireless medium is a shared resource and a wireless base station (or access point) often provides streaming services to multiple wireless clients.

Overview of Scalable Video Coding

SVC can be referred to as both the general concept of scalable video coding and the special extension of the MPEG4-AVC Standard. An SVC stream has a base layer and one or more enhancement layers. As long as the base layer is received, the receiver can decode the video stream. As more enhancement layers are received, the decoded video quality is improved. The bandwidth scalability of SVC includes temporal scalability, spatial scalability, and quality scalability. Temporal scalability refers to representing the same video in different temporal resolutions or frame rates. Spatial scalability refers to representing the video in different spatial resolutions or sizes. Normally, the picture of a spatial layer is based on the prediction from both lower-temporal layers and lower-spatial layers. Quality (or SNR) scalability refers to representing the same video in different SNRs or quality levels. To be precise, SNR-scalable coding quantizes the DCT-coefficients using different quantization parameters. SNR scalability in SVC includes coarse-grain scalability (CGS) and fine grain scalability (FGS). CGS is achieved using the concept of spatial scalability but with identical picture size. FGS is achieved by so-called progressive refinement (PR) slides, each of which represents a refinement of the residual signal that corresponds to a bisection of the quantization step size (QP increase of 6).

In the SVC extension the MPEG-4 AVC Standard, the base layer is an MPEG-4 AVC Standard bitstream for backwards compatibility. The temporal scalable bit-stream is generated using hierarchical prediction structures as illustrated in FIG. 1. SVC also introduces a variation of the CGS approach called medium-grain quality scalability (MGS), which allows a switching between different MGS layers in any access unit and the adjustment of tradeoff between drift and enhancement layer coding efficiency for hierarchical prediction structures.

### SUMMARY

These and other drawbacks and disadvantages of the prior art are addressed by the present principles, which are directed to streaming scalable video over fading wireless channels.

According to an aspect of the present principles, there is provided a method. The method includes building a model relating to a relationship between an average data rate and an average peak signal-to-noise ratio for a video sequence encoded using scalable video coding and having a base layer and one or more enhancement layers. The method also includes computing a vector relating to a set of average data rates for a particular boundary point on an achievable rate region for a transmission strategy. The boundary point is a function of a parameter set for a plurality of users. The achievable rate region is based upon the model. The method further includes scheduling the plurality of users to receive the video sequence over a wireless channel, such that at a given transmission time slot a particular one of the plurality of users associated with a maximum value is selected. The maximum value is based on the vector and a channel capacity available to the particular one of the plurality of users.

According to another aspect of the present principles, there is provided an apparatus. The apparatus includes a model builder for building a model relating to a relationship between an average data rate and an average peak signal-to-noise ratio for a video sequence encoded using scalable video coding and having a base layer and one or more enhancement layers. The apparatus also includes a user scheduler for computing a vector relating to a set of average data rates for a particular boundary point on an achievable rate region for a transmission strategy. The boundary point is a function of a parameter set for a plurality of users. The achievable rate region is based upon the model. The user scheduler schedules the plurality of users to receive the video sequence over a wireless channel, such that at a given transmission time slot a particular one of the plurality of users associated with a maximum value is selected. The maximum value is based on the vector and a channel capacity available to the particular one of the plurality of users.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1, an exemplary system 100 is shown to which the present principles may be applied, in accordance with an embodiment of the present principles;

FIG. 2 shows the server 130 of FIG. 1 in further detail, in accordance with an embodiment of the present principles;

FIG. 3 shows a method 300 for scalable video streaming over a fading wireless channel, in accordance with an embodiment of the present principles;

FIG. 4 is a diagram further showing step 310 of the method 300 of FIG. 3, in accordance with an embodiment of the present principles; and

FIG. 5 is a diagram further showing step 340 of the method 300 of FIG. 3, in accordance with an embodiment of the present principles.

### DETAILED DESCRIPTION OF PREFERRED EMBODIMENTS

The present principles are directed to a system and method for scalable video streaming over fading wireless channels.

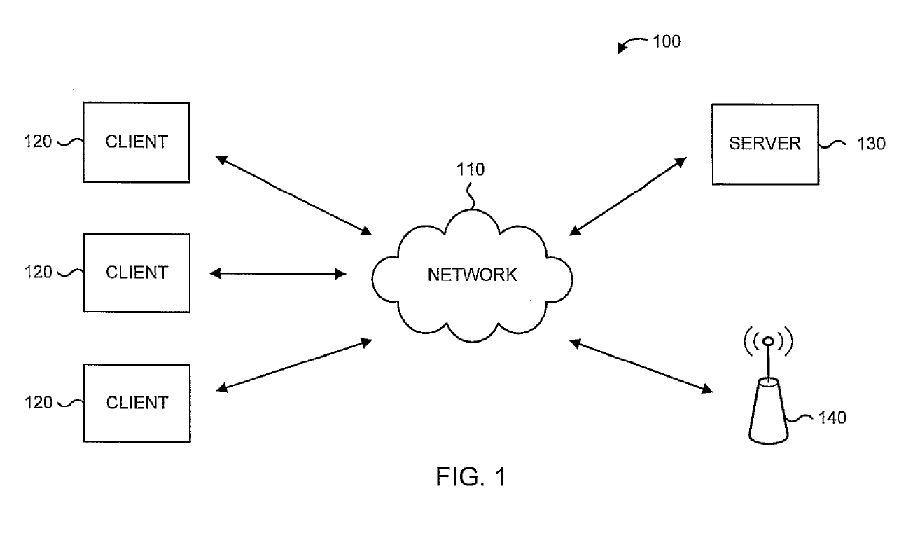

Referring now in detail to the figures in which like numerals represent the same or similar elements and initially to FIG. 1, an exemplary system 100 is shown to which the present principles may be applied, in accordance with an embodiment of the present principles. The communication system 100 includes one or more wireless networks, collectively represented by network 110. The communication system 100 further includes two or more client devices 120, representative of two or more respective users. The communication system 100 also includes a server 130. The communication system additionally includes one or more base stations, collectively represented by base station 140. In an embodiment, it is presumed that the wireless network is a fading wireless network. In an embodiment, the server 130 is configured to perform user scheduling, frame scheduling, and frame dropping, as described in further detail herein.

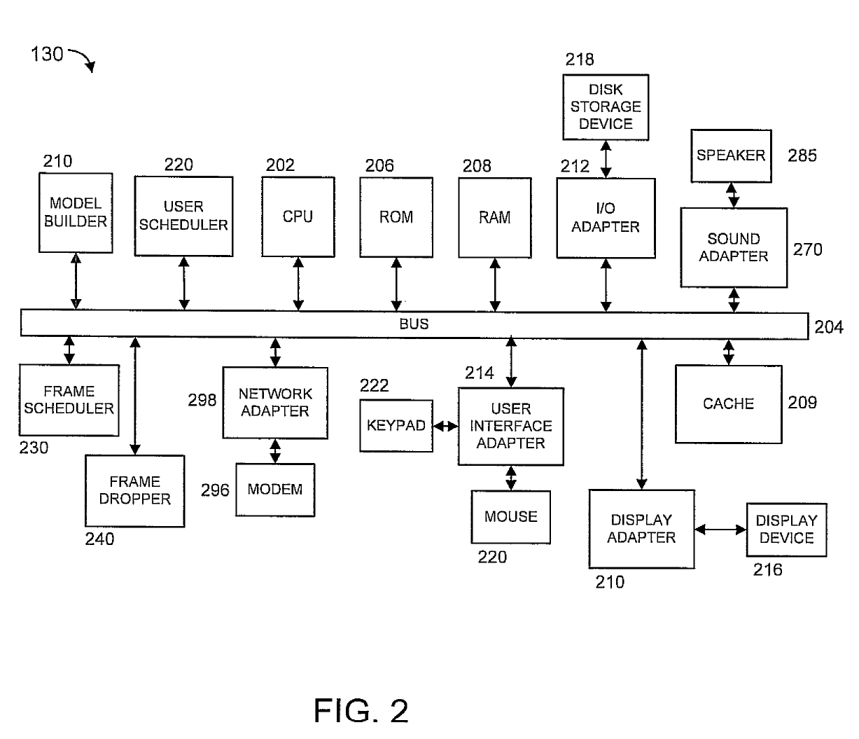

FIG. 2 shows the server 130 of FIG. 1 in further detail, in accordance with an embodiment of the present principles. The server 130 includes a model builder 291, a user scheduler 292, a frame scheduler 293, and a frame dropper 294. The model builder 291 builds a rate-PSNR model for a given video sequence encoded using scalable video coding, and having a base layer and one or more enhancement layers. The user scheduler 292 schedules the two or clients 120 to receive the video sequence over the network 210, as described in further detail herein. The frame scheduler 293 schedules the frames that are to be sent to the user, as described in further detail herein. The frame dropper 294 optionally drops one or more of the frames that are to be sent to the user based on certain criteria, as described in further detail herein. In the embodiment of FIG. 2, the model builder 291, the user scheduler 292, the frame scheduler 293, and the frame dropper 294 are all interconnected via a system bus 204.

The server 130 further includes at least one processor (CPU) 202 operatively coupled to other components via the system bus 204. A read only memory (ROM) 206, a random access memory (RAM) 208, a display adapter 210, an I/O adapter 212, a user interface adapter 214, a sound adapter 270, and a network adapter 298, are operatively coupled to the system bus 204. A display device 216 is operatively coupled to system bus 204 by display adapter 210. A disk storage device (e.g., a magnetic or optical disk storage device) 218 is operatively coupled to system bus 204 by I/O adapter 212. A mouse 220 and keyboard 222 are operatively coupled to system bus 104 by user interface adapter 214. The mouse 220 and keyboard 222 are used to input and output information to and from system 200. At least one speaker (herein after “speaker”) 285 is operatively coupled to system bus 204 by sound adapter 270. A (digital and/or analog) modem 296 is operatively coupled to system bus 104 by network adapter 198.

It is to be appreciated that while the model builder 291, the user scheduler 292, the frame scheduler 293, and the frame dropper 294, as well as the other elements of the server 130, are shown as separate elements, in other embodiments, one or more of the same may be combined with one or more other elements, while maintaining the spirit of the present principles. Moreover, it is to be appreciated that while the server 130 is shown separate from the base station 140, in other embodiments, one or more elements of the server, including, but not limited to, one or more of the model builder 210, the user scheduler 120, the frame scheduler 130, and the frame dropper 140, may be incorporated into the base station 140, into another server, and so forth. Further, it is to be appreciated that at least some of the elements shown and described with respect to server 130 are optional elements and, thus, may be omitted, depending upon the implementation. For example, in an embodiment, the sound adapter 270 and at least one speaker 285 may be omitted. Given the teachings of the present principles provided herein, one of ordinary skill in this and related arts will contemplate these and other variations to implementations of the present principles, while maintaining the spirit of the present principles.

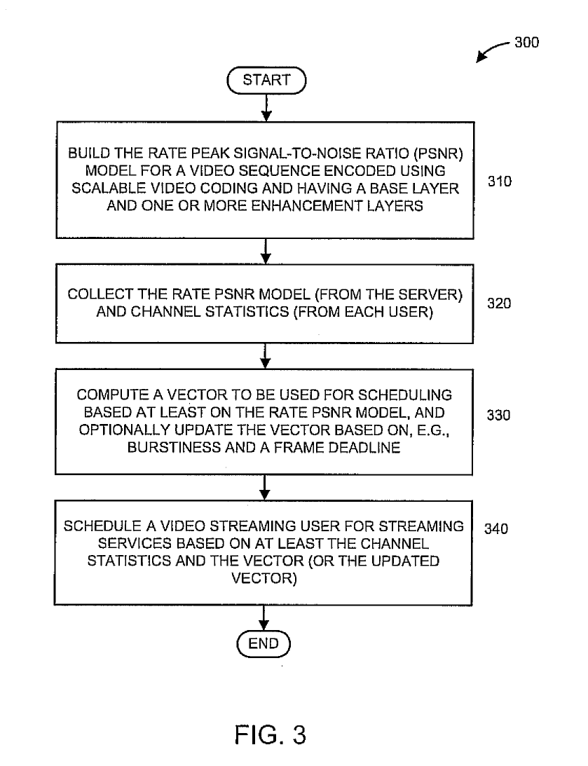

FIG. 3 shows a method 300 for scalable video streaming over a fading wireless channel, in accordance with an embodiment of the present principles. At step 310, a streaming server builds a rate-PSNR model for a video sequence encoded using scalable video coding and having a base layer and one or more enhancement layers. In an embodiment, step 310 involves a piece-wise linear function. In an embodiment, the model is built only once, and is then stored together with the scalable video stream. At step 320, when a BS is to schedule multiple streaming users, the BS collects the rate-PSNR model from the server and the channel statistics from each user. At step 330, the BS computes a vector μ to be used for scheduling based at least on the rate PSNR model, and optionally updates the vector based on, e.g., burstiness and a frame deadline. At step 340 the BS schedules the video streaming user for streaming services including a frame dropping strategy based at least on the channel statistics and the vector (or the updated vector). It is to be noted that use of the vector corresponds to the maximal scheduling policy described herein, while use of the updated vector corresponds to the dynamic scheduling policy described herein. Steps of the method 300 are described in further detail herein after with respect to various aspects of the present principles.

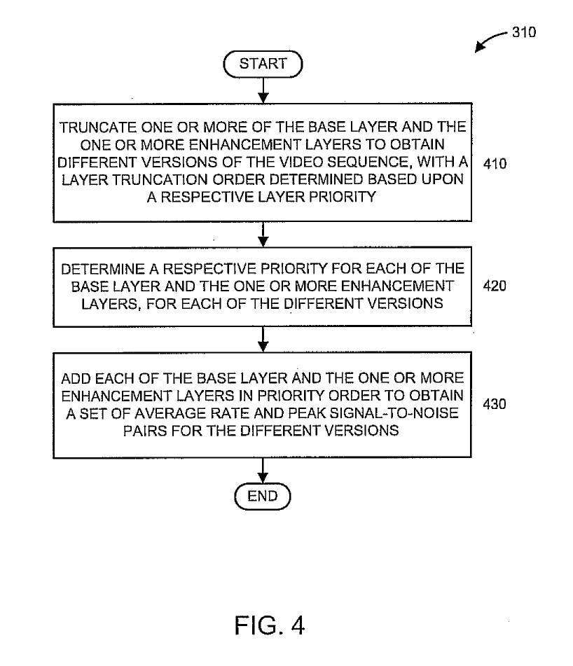

FIG. 4 is a diagram further showing step 310 of the method 300 of FIG. 3, in accordance with an embodiment of the present principles. At step 410, one or more of the base layer and the one or more enhancement layers are truncated to obtain different versions of the video sequence, with a layer truncation order determined based upon a respective layer priority. At step 420, a respective priority is determined for each of the base layer and the one or more enhancement layers, for each of the different versions. At step 430, each of the base layer and the one or more enhancement layers are added to model in priority order to obtain a set of average rate and peak signal-to-noise pairs for the different versions of the video sequence. Steps 410, 420, and 430 are described in further detail herein after with respect to various aspects of the present principles.

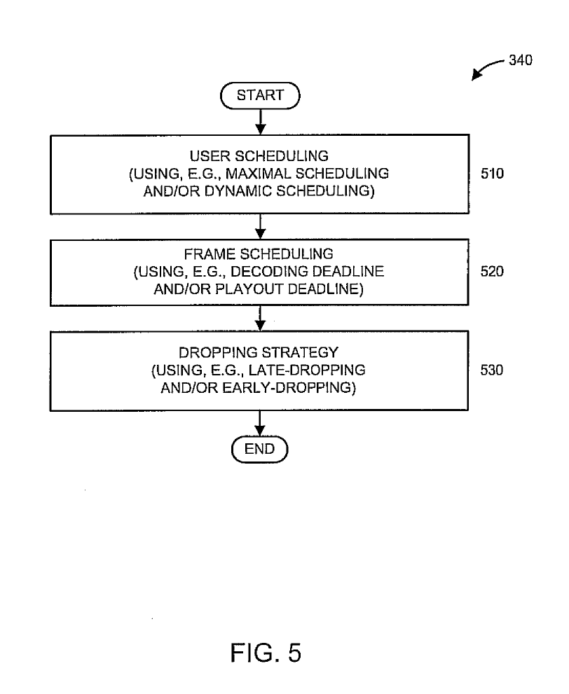

FIG. 5 is a diagram further showing step 340 of the method 300 of FIG. 3, in accordance with an embodiment of the present principles. Step 340 may be considered to involve the following three components: user scheduling 510; frame scheduling 520; and dropping strategy 530.

With respect to user scheduling 510, in an embodiment, we use a maximal scheduling policy and/or a dynamic scheduling policy. In an embodiment, the maximal scheduling policy involves, at each time slot, the user with the maximum μᵢ Cᵢ being selected for scheduling, where Cᵢ is the channel capacity of user i, and μᵢ is the parameters computed per step 230 of FIG. 2. The maximal scheduling policy and the dynamic scheduling policy are described in further detail herein after.

With respect to frame scheduling 520, after the user is selected, we choose the frames of that user in the order of their decoding deadline. In an embodiment, we can select frames based on, e.g., a decoding deadline and/or a playout deadline. In an embodiment, for the frames with the same decoding deadline, we choose the ones with the highest priority which is computed per step 310 of FIG. 3. The decoding deadline and the playout deadline are described in further detail herein after.

With respect to the dropping strategy 530, we have two types of dropping. The first is late-dropping. When the playout deadline of a frame is passed, the frame is dropped. The second is early-dropping. Early dropping is based on the achievable rates for all users computed per step 330 of FIG. 3. We find the minimum priority such that the average data rate of packets with priority higher than or equal to the minimum priority does not exceed the achievable rates computed per step 330 of FIG. 3. All packets with priority lower than the minimum priority are dropped even if their deadlines are not passed. Late-dropping and early-dropping are described in further detail herein after.

Steps 510, 520, and 530 are described in further detail herein after with respect to various aspects of the present principles.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable medium such as a semiconductor or solid state memory, magnetic tape, a removable computer diskette, a random access memory (RAM), a read-only memory (ROM), a rigid magnetic disk and an optical disk, etc.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed,

It is to be appreciated that while one or more embodiments of the present principles are described herein with respect to the SVC extension of the MPEG-4 AVC Standard, the present principles are not solely limited to the same and, thus, given the teachings of the present principles provided herein, may be readily applied by one of ordinary skill in this and related arts to other video coding standards, recommendations, and/or extensions thereof, while maintaining the spirit of the present principles.

Moreover, it is to be appreciated that while one or more embodiments of the present principles are described herein with respect to temporal scalability and MGS scalability, the present principles are not limited to solely the preceding and, thus, given the teachings of the present principles provided herein, may be readily applied by one of ordinary skill in this and related arts to other aspect of SVC, including but not limited to, spatial scalability, SNR scalability, coarse grain scalability, fine grain scalability, and so forth, while maintaining the spirit of the present principles.

As noted above, the present principles are directed to streaming scalable video over fading wireless networks. In one or more embodiments, we focus on the issue of multi-user video streaming over a shared wireless channel. As noted above, an SVC bitstream includes a base layer and one or more enhancement layers. As long as the base layer is received, the receiver can decode the video stream. As more enhancement layers are received, the decoded video quality is improved. With an SVC-encoded stream, the scheduler at the wireless base station can adapt to changing wireless channel conditions by transmitting a subset of enhancement layers.

We identify two issues under such a scenario and develop solutions for them. The first issue is how to share the wireless radio resources in order to optimize overall streaming video quality. A fundamental characteristic of wireless channels is the random time-varying of the channel states, which is called fading. Under the fading wireless channel model, channel-state-dependent scheduling is often used to exploit the multi-user diversity. We formulate the problem under this model as maximizing the weighted sum of video quality of all users subject to the achievable long-term (ergodic) rate constraint. To solve the problem, we develop a long-term radio resource allocation algorithm which determines the wireless scheduling policy and the parameters used by the scheduling policy. The scheduling policy has the following property: at each time slot, the user with the largest μᵢCᵢ is selected for scheduling, where Cᵢ is the channel capacity and μᵢ is a parameter for user i. The set of parameters (μᵢ,i=1, . . . ,n) is computed using a gradient-based approach. We rigorously prove that the scheduling policy together with the computed parameters achieves the global optimum of the weighted sum of video quality function under mild conditions. This is quite significant as the formulated objective function (video quality) is not concave in the space of parameters (μᵢ, i=1, . . . ,n).

Further with regard to the first issue, in another embodiment, we first develop a model to characterize the relationship between the time-averaged data rate and the video quality (measured by PSNR), which turns out to be a concave, piece-wise linear function. We consider a general TDMA scheduling policy: at each time slot, only one user is selected for scheduling. We then formulate the problem as a long-term radio resource allocation problem where the objective is to maximize the weighted sum of the time-averaged video quality of all streaming users. We show that the optimal scheduling policy has the following property called maximal scheduling: at each time slot, the user with the largest μᵢCᵢ is selected for scheduling, where Cᵢ is the channel capacity and is a parameter for user i. We then design an algorithm to find the set of parameters {μᵢ,i=1, . . . , n} (where n is the number of users) to maximize the weighted sum of PSNR of all n streaming users. We then design an online scheduling algorithm that uses the aforementioned maximal scheduling policy and the computed optimal parameters μ=(μ₁,μ₂, . . . ,μₙ) to select the user for scheduling in each slot. In addition, we also design a frame/layer dropping strategy based on the achievable rate for each user obtained in the aforementioned long-term resource allocation algorithm.

The second issue is how to design online scheduling algorithms that meet the video traffic QoS requirements in addition to exploiting multi-user diversity. Previous radio scheduling algorithms often only consider the deadline requirement of video traffic and channel conditions but ignore the bursty rate requirement of video traffic. We propose two exemplary scheduling algorithms. The static scheduling algorithm simply uses the results obtained from the aforementioned long-term resource allocation algorithm. The dynamic scheduling algorithm is based on the static scheduling algorithm but further adapts the parameters used by the scheduling policy to meet the instantaneous rate, deadline requirement of video traffic and wireless channel conditions. In this regard, we first compute the instantaneous rate requirement r̅ₜ of video traffic of each user i based on the video frame sizes and their deadlines. We then formulate the problem as maximizing minᵢ₌₁ⁿrᵢ(μ)/ r̅ᵢ by choosing appropriate scheduling parameters μ=(μ₁, . . . ,μₙ). This problem is non-convex and non-differentiable. However, we first convert the problem into a simpler problem (and show the equivalence of the two problems). We then develop a gradient-based approach to solve the problem. We also prove the gradient-based approach converges to the optimal solution to the formulated problem even though the objective function is not convex. We also design frame dropping strategies for both the static and dynamic scheduling algorithms, which determine when to drop video frames and which frames to be dropped.

Thus, we advantageously provide the following: (1) we develop an empirical model to relate the video quality and the average throughput; (2) we design a long-term radio resource allocation algorithm in order to optimize the overall video quality of multiple users; and (3) we devise two on-line scheduling schemes that jointly consider the deadline and the bursty rate requirement of video traffic and the varying wireless channel conditions. Our schemes also determine when video packets need to be dropped and which of them should be dropped.

Rate-Quality Model and Prioritization of Layers

A natural criteria for measuring video quality is distortion, which is defined as the mean square error of the reconstructed pixel values compared to the original uncompressed pixel values. Another important metric for measuring video quality is PSNR (Peak Signal to Noise Ratio). For a single video frame, PSNR is defined as PSNR=10 log₁₀(255²/D), where D is the distortion. However, for a sequence of video frames, the relationship between average PSNR and the average distortion is not direct, because both averages are taken over multiple frames with respect to their own values. Some researchers have used distortion as a measure of the video quality and developed models that relate data rate and distortion. But PSNR is more widely used as the final performance metric in the literature. Therefore, we choose to model the relationship between the average data rate and the average PSNR directly. In the prior art, different data rates are obtained by encoding using different quantization parameters. To serve the purpose of scalable video streaming, we obtain different data rates by sequentially truncating some layers of an SVC-encoded video stream.

There are many possible ways to truncate SVC-encoded streams. For example, each video frame can be truncated to different SNR (quality) layers. However, allowing arbitrary truncation leads to very different video quality for each frame, which is undesirable, and also makes the rate-quality model more difficult to build. Therefore, in an embodiment, we truncate the video stream such that frames in the same temporal layer are truncated to the same SNR layer. In an embodiment, a layer can be specified by its temporal level t and its SNR level q. Thus, in an embodiment, the frames belonging to the same layer (t,q) are either all kept or all removed in a truncated video sequence.

In one embodiment, we consider truncation defined by a tuple (q₀,q₁, . . . ,q_{L}) with q₀≧q₁≧ . . . ≧q_{L}≧−1, where L represents the highest temporal layer. In the truncation defined by (q₀,q₁, . . . ,q_{L}), frames with temporal layer k are truncated to keep up to qₖ SNR layers. When qₖ=−1, this means that the whole temporal layer k is dropped, and when qₖ=0, this means that only the base layer of temporal layer k is kept. We enforce that the maximum SNR layer in a higher temporal layer not be smaller than that in a lower temporal layer (i.e., qₖ≧qₖ₊₁) because a frame in a higher temporal layer may depend on that in a lower temporal layer. When the whole temporal layer k is dropped, we reconstruct it using linear interpolation from lower temporal layers that are not dropped and then we compute the average PSNR of all frames for a fair evaluation.

When we have to drop video packets at bad wireless channel conditions, we will drop them in a certain order based on their importance/priority. As a result, we limit the truncation order of different layers by their priorities. As noted above, a layer is specified by (t, q) which represents the qth SNR layer of the tth temporal layer. If q=0, then layer (t, 0) is a base layer of a temporal layer t. The priorities of the base layers of each temporal layer are decided by their dependence relationship: the lowest temporal base layer has the highest priority. In an embodiment, the priorities of other SNR layers are determined using the following algorithm. We start from the configuration where each temporal layer has only a base layer. At each iteration, the layer with the highest ratio of PSNR increase to rate increase is assigned with the next highest priority. The detailed algorithm is presented as follows.

Pseudo-Code to Determine the Priority Order:

/* Assume that r(q) and S(q) (where q = (q₀, q₁, . . . , q_{L})) represent

the rate and PSNR of the SVC stream truncated according to the tuple q.
Note that layers are added sequentially and lower SNR layers should
always be added before higher SNR layers in the same temporal layer.
Q is defined as the highest SNR layer in each temporal layer

*/
1: Initially, q₀ = q₁ = . . . = q_{L} = 0, r(0) and S(0) are the rate and

the PSNR when q = (0, 0, . . . , 0).

```
  2: while not all layers are added to the truncated stream do
  3: for t = 0 to L do
  4: if qₜ < qₜ₋₁ for t > 0 or qₜ < Q for t == 0 then
  5: /* layer (t, qₜ + 1) can be added without violating Q ≧ q₀ ≧
  q₁ . . . ≧ q_{L} */
  6: q′ = (q₀, . . . qₜ₋₁, qₜ + 1, qₜ₊₁, . . . , q_{L})
$7 \text{:} psnr\_inc \_rate ( t ) = \frac{S ( {q}^{′} ) - S ( 0 )}{r ( {q}^{′} ) - r ( 0 )}$
  8: end if
  9: end for
10: Find t* that maximizes psnr_inc_rate(t)
11: The layer (t*, q(t*) + 1) is assigned the next highest priority
12: q(t*) = q(t*) + 1 /* add layer (t*, q(t*) + 1) */
13: end while
```

For each rate obtained by sequentially adding the layers with decreasing priority, we can compute the distortion and PSNR compared with the original video sequence. The average PSNR is a piece-wise linear function of the average rate consisting of two line segments. The left line segment corresponds to the temporal scalability (i.e., some temporal frames are completely dropped and only the base layers are kept). The right line segment corresponds to the SNR scalability (i.e., all base layers are kept and some SNR layers are dropped). We next perform linear regression on each line segment and obtain a model, where the PSNR value Si can be written as follows:

$${S}_{i} ( r ) = \{ \begin{matrix}{S}_{i}^{0} + {L}_{i} ( r - {r}_{i}^{0} ) & if r \leq {r}_{i}^{0} \\ {S}_{i}^{0} + {K}_{i} ( r - {r}_{i}^{0} ) & if {r}_{i}^{0} < r \leq {r}_{i}^{max} \\ {S}_{i}^{0} + {K}_{i} ( {r}^{max} - {r}_{i}^{0} ) & else\end{matrix} \qquad ( 1 )$$

where rᵢ⁰,Sᵢ⁰ are the rate and the PSNR, respectively, at the intersection of the two line segments, and the last line specifies the maximum encoding rate of each video. That is, in an embodiment, rᵢ⁰,Sᵢ⁰ are the rate and PSNR or user i when only the base layers of all temporal layers are kept. In one or more embodiments, depending upon the implementation, we may also want to use a minimum coding rate to maintain a minimum video quality. However, we assume that such a requirement can be achieved by admission control. For example, if the resulting data rate of user i is less than its minimum rate requirement, user i will be denied for admission.

Note that Lᵢ>Kᵢ>0 based on the practical video modeling, and the function Sᵢ(r) is therefore a concave function with respect to r.

Long-Term Radio Resource Allocation and On-Line Scheduling

When multiple users request for streaming service of different video sequences concurrently through a wireless base station, the MAC scheduler in the base station needs to decide: (i) how much bandwidth should he allocated to each user; and (ii) how to achieve the desired bandwidth, in order to optimize the overall video quality. In a non-fading wireless network, the second problem can be simply solved by TDMA. But mobile networks often experience fast fading. In a fading wireless network, channel state dependent scheduling is often used to exploit multi-user diversity. Instead of considering the rate allocation on a short-term per-slot basis, we consider the long-term average resource allocation for each user in order to optimize average video quality under the assumption of fading wireless channels.

Problem Formulation

We assume that the link from the base station to each mobile client is fading with a known distribution. We consider a block fading model where the fading is constant in each time slot and changes independently from one time slot to the other. The complex baseband model of the i^{th} user channel is given by the following:

yᵢ=h,x+z (2)

where yᵢ is the received signal, hᵢ is the channel gain, x is the transmitted signal, and z is the complex Gaussian noise with zero mean and unit variance (we assume that the transmitted and the received signal are normalized with respect to the noise). We assume a fixed transmission power |x|¹=ρ. We define the channel state h=(h₁,h₂, . . . ,hₚ) as the vector of all individual channel gains. We assume that the channel capacity for each user at each time slot t is as follows:

C(hᵢ(t))=B log(1+ρ|hᵢ(t)|²) (3)

where B is the channel bandwidth. We assume a discrete time system with a TDMA transmission strategy as follows: at each time slot, the server picks only one user (which may depend on the channel states of all the users) and sends information with the supportable rate of the channel of this scheduled user. It is to be appreciated that with practical code usually B log(1+ρ|hᵢ(t)|²/Γ) can be achieved, where Γ≧1 represents the gap between the actual coding scheme and the Shannon capacity. All of our analysis and algorithms can be applied to this achievable rate equation.

Our objective is to maximize the weighted sum of average PSNR of all users as follows:

$$max {\sum }_{i = 1}^{n} {ω}_{i} {S}_{i} ( {r}_{i} ) \\ s . t . r ∈ \qquad ( 4 )$$

where Sᵢ is the PSNR of user i as modeled in Equation (1), ωᵢ is the weight of user i, r=(r₁, . . . ,rₙ), and [symbol] is the achievable ergodic rate region.

The major challenge in solving problem (4) is that the achievable rate region [symbol] cannot be explicitly specified in a fading environment. We next address this challenge by characterizing the achievable rate legion [symbol] and its property.

Achievable Rate Region [symbol] —Embodiment 1

Let C(h)=B log(1+ρ|h|²) denote the instantaneous capacity of the single link with the channel gain h. The achievable rate region for a TDMA strategy is given by

[symbol]

={r:rᵢ≦Eₕ[I{s(h)=i}C(hᵢ)], 1≦i≦n}

where s(h) is the index of the scheduled user for channel state h, and I{s(h)=i} is an indicator function which is equal to one if s(h)=i, and is equal to zero otherwise. We note that for the TDMA strategy, the scheduling function s(h) in general can be randomized. We show later that for any continuous distribution for the channel state h, each rate tuple in the boundary B can be achieved with a static scheduling function s(h) that returns only one index for a given channel state. Nonetheless, we consider the general randomized scheduling function to first show the convexity of the achievable rate region and then obtain the boundary points. Suppose that r⁽¹⁾ and r⁽²⁾ are in the achievable rate region [symbol] and are obtained by two scheduling functions s⁽¹⁾(h) and s⁽²⁾(h). In other words, as follows:

rᵢ^{(k)}=Eₕ[I{s^{(k)}(h)=i}C(hᵢ)], 1≦i≦n, k=1,2.

Thus, any intermediate point τr⁽¹⁾+(1−τ)r⁽²⁾, 0≦τ≦1 also belongs to the region [symbol] by considering the randomized scheduling function as follows:

$$s ( h ) = \{ \begin{matrix}{s}^{( 1 )} with probability τ \\ {s}^{( 2 ) } with probability ( 1 - τ )\end{matrix}$$

Therefore, we have proved that the achievable rate region [symbol] is convex.

Next we define the boundary of the achievable rate region as B={r∈ [symbol] there exists no r′∈ [symbol] such that r [symbol] r′}, where r [symbol] r′ means that all components of r are less than or equal to r′ and at least one component in r is less than the corresponding one in r′. In other words, the boundary B is the set of the Pareto-optimal achievable rate tuples. Due to the non-decreasing property of the PSNR function Sᵢ(r), there must exist an optimal solution to problem (4) in the boundary region B of the achievable rate region. Therefore, to solve the PSNR optimization problem (4), it is sufficient to look for a solution on the boundary B.

The boundary surface B can be obtained by solving the following optimization problem:

$${max}_{r ∈ R} {\sum }_{i = 1}^{n} {μ}_{i} {r}_{i} \qquad ( 5 )$$

for all μ=(μ1,μ₂, . . . ,μₙ) that is a unit norm vector with positive real elements. To solve the above problem, for each channel state h we have the following:

$${max}_{s ( h )} {\sum }_{i = 1}^{n} {μ}_{i} Pr \{ I ( s ( h ) = i ) \} C ( {h}_{i} ) .$$

Therefore, the solution for the scheduling function is given by the following:

s(h)=i [symbol] h∈{h: μᵢC(hᵢ)>μₖC(hₖ),∀k≠i} (6)

In the solution given by Equation (6) we have ignored the set of channel states h for which μᵢC(hᵢ)=μₖC(hₖ) which in fact has zero probability if the distribution of h is continuous. We call the scheduling policy defined by s(h) in Equation (6) as the maximal scheduling policy, due to the fact that this scheduler only obtains the set of rates in the boundary which are the set of Pareto-optimal rate tuples.

Solution to Problem (4)

We can now view a boundary point r=(r₁, . . . ,rₙ) as a function of the parameter set μ=(μ₁, . . . ,μₙ), where the average rate rᵢ of user i can be written as follows:

rᵢ=E└C(hᵢ)I(μᵢC(hᵢ)>μⱼC(hⱼ) for all j≠i)┘ (7)

Let γᵢ=ρ|hᵢ|² denote the SINR of the user i with PDF function ƒ_{γi}(γ) and CDF function F_{γi}(γ). Let R(γ)=B log(1+γ). Thus, the rate rᵢ can be computed as follows:

rᵢ(μ)=∫₀^{∞}R(x)Π_{j≠1}F_{γi}(R⁻¹(μᵢR(x)/μⱼ))ƒ_{γi}(x)dx (8)

Now our objective is simply to address the following:

$$maximize Y = {\sum }_{i = 1}^{n} {w}_{i} {S}_{i} ( {r}_{i} ( \underline{μ} ) ) \qquad ( 9 )$$

Note that Sᵢ(rᵢ) is a non-decreasing concave function of rᵢ.

A general approach to solve an optimization problem is the gradient-based method: we start with some point μ⁰, and in each step k, we find the gradient and update the vector μ^{(k)} along a direction d that is related to the gradient:

μ^{(k+1)=μ}^{(k)}+α^{(k)}d^{(k)} (10)

where d^{(k)}=D^{(k)}∇Y(μ^{(k)}), where D^{(k)} is a positive definite symmetric matrix and ∇Y(μ^{(k)}) is the gradient of Y with respect to μ^{(k)}.

However, the challenge with problem (9) is (i) the function Y is generally not concave (or convex) with respect to μ, and (ii) the function Y is not differentiable at the points when some rᵢ=rᵢ⁰ or rᵢ=rᵢ^{max}. When a function is not concave or convex, the solution generated by the gradient-based approach is often only a local maximum (or minimum) but not a global maximum. Hereinafter, we develop an algorithm and prove that the limit point of the algorithm is the global maximum of problem (9) under mild conditions.

To resolve the second issue, we note that although Sᵢ is not differentiable at rᵢ=rᵢ⁰ or rᵢ=rᵢ^{max}, it has one-sided derivatives. For functions with one-sided derivatives, the following lemma is a simple generalization of the first-order necessary optimality conditions.

Lemma 2 If μ* is a local maximum of Y, then the following applies:

Yᵢ₊′(μ*)≦0 (11)

Yᵢ₋′(μ*)≧0 (12)

for all 1≦i≦n, where

$${Y}_{1 +}^{′} ( {\underline{μ}}^{*} ) = \frac{\partial Y}{\partial {μ}_{i} +} ( {\underline{μ}}^{*} )$$

is the right-sided partial derivative and

$${Y}_{i -}^{′} ( {\underline{μ}}^{*} ) = \frac{\partial Y}{\partial {μ}_{i} -} ( {\underline{μ}}^{*} )$$

is the left-sided partial derivative.

The proof is straightforward because if it is not true for any i, we can perturb μᵢ sufficiently small to increase the objective value Y.

Now with the one-sided partial derivative, we can obtain an iterative modified gradient-based solution as follows. First, we compute the modified gradient g^{(k)}=(g₁^{(k)},g₂^{(k)}, . . . ,gₙ^{(k)}) in each iteration k:

$${g}_{i}^{( k )} = \{ \begin{matrix}0 , & if {Y}_{i +}^{′} ( {\underline{μ}}^{( k )} ) \leq 0 and {Y}_{i -}^{′} ( {\underline{μ}}^{( k )} ) \geq 0 \\ {Y}_{1 +}^{′} ( {\underline{μ}}^{( k )} ) & if {Y}_{i +}^{′} ( {\underline{μ}}^{( k )} ) > 0 and {Y}_{i +}^{′} ( {\underline{μ}}^{( k )} ) \geq - {Y}_{i -}^{′} ( {\underline{μ}}^{( k )} ) \\ {Y}_{i -}^{′} ( {\underline{μ}}^{( k )} ) , & otherwise \end{matrix} \qquad ( 13 )$$

Let i₀=arg max(|gᵢ^{(k)}|). The ascent direction is chosen to be d^{(k)}=(0, . . . ,gᵢ_{₀}^{(k)}, . . . ,0). In other words, the ascent direction d^{(k)} is all zero except the i₀th element, which takes the value gᵢ_{₀}^{(k)}.

Step-size selection using A modified Armijo Rule: in any gradient-based approach, we also need to choose the step size α^{(k)} appropriately in order for the algorithm to converge to a local maximum. The Armijo rule is a simple but effective rule to choose the step size when the gradient exists. For fixed scalars α₀,σ,β, the Armijo rule chooses the minimum non-negative m such that αₖ=α₀β^{m} and

Y(μ^{(k)}+α₀β^{m}d^{(k)})−Y(μ^{(k)})≧σα₀β^{m}∇Y(μ^{(k)})^{T}d^{(k)} (14)

where ∇Y(μ^{(k))}^{T} is the transpose of the gradient of Y with respect to μ. In our problem, the gradient ∇Y(μ^{(k)}) may not exist, so we define a modified Armijo rule using d^{(k)} to replace the gradient ∇Y(μ^{(k)})^{T} in Equation (14). The pseudo-code of our algorithm is listed next.

A1: Pseudo-code to find the optimal solution for problem (9)

/* ε,σ,α₀ are positive constant values. ε is close to 0, and 0 < σ < 1 . */
1: Select a starting point μᵢ⁽⁰⁾ = 1 for all 1 ≦ i ≦ n.
2: Compute d⁽⁰⁾ from μ⁽⁰⁾
3: k=0
4: while |d^{(k)}|²≧ ε do
5: /* Choose the step size */
6: α = α₀
7: while Y μ^{(k)} + α d^{(k)}) − Y(μ^{(k)})< σ α ·|d^{(k)}|² do
8: α = α · β
9: end while
10: μ^{(k+1)} = μ^{(k)} + α · d^{(k)}
11: k = k + 1
12: Re-compute d^{(k)} from μ^{(k)}
13: end while

With the choice of the gradient-based approach and the Armijo rule, we can show the convergence of the algorithm, which is summarized next. Note that step 4 of the algorithm employs finite stopping conditions. In the convergence analysis, we always assume the algorithm never stops and study the limit point of μ^{(k)} and Y^{(k)}.

Lemma 3 Algorithm A1 converges to a point μ* satisfying the necessary conditions of a local maximum in Equations (11,) and (12,), assuming that the finite stopping condition is removed.

Optimality of the Algorithm A1

Theorem 1 The limit point of the algorithm A1 is a global maximum of function Y assuming that the PSNR function Sᵢ(rᵢ) is non-decreasing, concave, and continuously differentiable with respect to rᵢ.

Online Scheduling for SVC Video Streaming

An online scheduling algorithm for real-time video applications needs to address three issues:

1. User scheduling: at each time slot, which user should be scheduled?

2. Frame scheduling: after a user is selected, which packets/frames of the selected user should be transmitted?

3. Dropping strategy: when does it need to drop frames and which frames should be dropped?

The resource allocation algorithm presented in the section produces two results: (1) the vector μ used for user-scheduling; and (2) the achievable average rate rᵢ for each user i. We next describe two online scheduling schemes exploiting these results. In the first scheme, we simply apply the results obtained from the resource allocation algorithm. In the second scheme, we also consider the bursty and dynamic arrival and the deadline of video frames.

Static Scheduling Scheme

In this first scheme, the vector μ is computed from the previous section and is fixed during the process of streaming (μ may be re-computed when new users join or some users leave). At each time slot, the user with the largest μᵢCᵢ is chosen for scheduling, where Cᵢ is the current channel capacity of user i, and the vector μ={ρ₁,μ₂, . . . ,μₙ} is computed from the long-term resource allocation algorithm in the previous section.

Frame scheduling for the selected user is based on both the deadline and priority of the packets. We differentiate between two types of deadlines, namely the Playout deadline and the Decoding deadline. The Playout deadline is the time a frame needs to be displayed. The decoding deadline is the earliest time that a frame is needed for decoding itself or other frames. The decoding deadline of a frame can be computed as the minimum playout deadline of all frames that depend on it. Table I shows the playout deadline and the corresponding decoding deadline of a video sequence encoded using SVC with hierarchical B-frames with GOP size 8. Note that the playout deadline of each frame is fixed but the decoding deadline may change. In Table I, if the flame β₁ is dropped, then the decoding deadline of B₂, B₄, and P₈ will all become 2.

We then schedule packets of a given user in the order of their decoding deadline. Those packets with the same decoding deadline are scheduled in the order of their priority, which is also described herein.

As to the dropping strategy, there are two types of dropping. The first is late dropping, which happens when the playout deadline of a packet is passed. If the base layer of a frame is dropped, all dependent frames are dropped too. Note that when all packets of a frame are either successfully transmitted or dropped, the decoding deadline of the frames that it depends on need to be re-computed.

TABLE I
PLAYOUT DEADLINE VS DECODING DEADLINE

| | Frame | | | | | | | | |
|---|---|---|---|---|---|---|---|---|---|
| | I₀ | P₈ | B₄ | B₂ | B₁ | B₃ | B₆ | B₅ | B₇ |
| playout deadline | 0 | 8 | 4 | 2 | 1 | 3 | 6 | 5 | 7 |
| decoding deadline | 0 | 1 | 1 | 1 | 1 | 3 | 5 | 5 | 7 |

The second type of dropping is early dropping. With the achievable rate computed as described herein before, we can pre-determine which layers should be dropped based on the rate requirement. We find the minimum priority such that the average data rate of the packets with priority higher than or equal to the minimum priority does not exceed the achievable rate computed herein before. All packets with priority lower than the minimum priority are dropped at the beginning of the video streaming.

Dynamic Scheduling Scheme

The dynamic scheduling is built on top of the static scheduling scheme with two additional enhancements. The first enhancement is based on the user scheduling. At each time slot, still, the user with the largest μᵢCᵢ is selected for scheduling. However, the vector μ is periodically updated to reflect both the bursty arrival and the deadline of video traffic.

Assume that for user i, the size of total packets that need to be transmitted before the deadline Tⱼ is Qⱼ. We define the target rate r̅ᵢ for user i to be the following:

$${\overline{r}}_{i} = {{max}_{j = 1}}^{n} \frac{{Q}_{j}}{{T}_{j} - t} \qquad ( 15 )$$

where t is the current time.

Now with the target rate r̅ᵢ for each user i, we ask whether there exists a vector of μ such that the target rate r̅ᵢ can be satisfied for every user i. We consider the following max-min problem:

$$maximize min \frac{{r}_{i} ( \underline{μ} )}{{\overline{r}}_{i}} \qquad ( 16 )$$

over all possible choices of μ. Clearly, if the optimal value of Equation (16) is larger than or equal to 1, then the target rate r̅ is schedulable and vice versa. The problem (16) is not easy to solve as (i) the problem is non-convex and (ii) the derivative does not exist and the gradient-based approach cannot be directly applied. However, we prove the following result.

Theorem 2 Solving problem (16) is equivalent to solving the following problem: find μ such that

$$\frac{{r}_{1} ( \underline{μ} )}{{\overline{r}}_{1}} = \frac{{r}_{2} ( \underline{μ} )}{{\overline{r}}_{2}} = … = \frac{{r}_{n} ( \underline{μ} )}{{\overline{r}}_{n}} , \qquad ( 17 )$$

assuming that the channel distribution function ƒᵣ(γ) is a continuous function of γ for all i.

Proof. First we show that at the optimum solution of Problem (16), the condition (17) is satisfied. If it is not satisfied, then max(rᵢ(μ)/ r̅ᵢ)>min(rᵢ(μ)/ r̅ᵢ). Let i₀=arg max rᵢ(μ)/ r̅ᵢ(μ). Now if we choose \tilde{μ}=(\tilde{μ}₁,\tilde{μ}₂, . . . ,\tilde{μ}ₙ) such that \tilde{μ}ᵢ=μᵢ for all i≠i₀, and \tilde{μ}ᵢ_{₀}<μᵢ_{₀}. From Equation (8), rᵢ(\tilde{μ})>rᵢ(μ) for all i≠i₀ and rᵢ_{₀}(\tilde{μ})<rᵢ_{₀}(μ). Since rᵢ is a continuous function of μ, we can choose \tilde{μ}ᵢ_{₀} sufficiently close to μᵢ_{₀} such that:

$$\frac{{r}_{{i}_{0}} ( \underline{\tilde{μ}} )}{{\overline{r}}_{{i}_{0}}} \geq {min}_{i \neq {i}_{0}} \frac{{r}_{i} ( \underline{\tilde{μ}} )}{{\overline{r}}_{i}} > {{min}_{i \neq {i}_{0}}}^{n} \frac{{r}_{i} ( \underline{\tilde{μ}} )}{{\overline{r}}_{i}}$$

Therefore, the following applies:

$${{min}_{i = 1}}^{n} \frac{{r}_{i} ( \tilde{\underline{μ}} )}{{\overline{r}}_{i}} > {{min}_{i = 1}}^{n} \frac{{r}_{i} ( \underline{μ} )}{{\overline{r}}_{i}}$$

This contradicts to the fact that μ maximizes the objective function in (16), Thus, the condition (17) must be satisfied if μ is the optimal solution of (16).

Second, we prove that the value rᵢ/ r̅ᵢ is unique if the condition (17) is satisfied. Suppose that both μ and \tilde{μ} can satisfy the Equation (17). If rᵢ(μ)<rᵢ(\tilde{μ}) for all i, the scheduling policy based on \tilde{μ} is strictly better than μ. The rate vector r achieved using the maximal scheduling policy based on any μ is Pareto-optimal. The contradiction implies that rᵢ(μ)=rᵢ(\tilde{μ}). Therefore, the solutions to the two problems (16) and (17) are equivalent.

To solve problem (17), we define g=(g₁, . . . ,gₙ), g̅, and h(μ) as follows:

$${g}_{i} ( \underline{μ} ) = {r}_{i} ( \underline{μ} ) / {\tilde{r}}_{i} \\ \overline{g} = {\sum }_{i = 1}^{n} {g}_{i} ( \underline{μ} ) / n \\ h ( \underline{μ} ) = \frac{1}{2} {\sum }_{i = 1}^{n} {( {g}_{i} ( \underline{μ} ) - \overline{g} )}^{2} . \qquad ( 18 )$$

In each iteration k, we compute g̅^{(k)} and treat it as a fixed value during the iteration. We then solve the problem of minimizing the function h(μ) in Equation (18) using the Gauss-Newton method. To do so, we choose the direction as follows:

d^{(k)}=(∇_{g}(μ)∇_{g}(μ)^{T})⁻¹∇_{g}(μ)(g(μ)− g̅^{(k)).} (19)

and update μ^{(k)} as follows:

μ^{(k+1)}=μ^{(k)}−α^{(k)}d^{(k)}

where α^{(k)} is the step size chosen by Armijo rule. In other words, α^{(k)=α}₀β^{m} where m is the minimum non-negative m such that:

h(μ^{(k)})−h(μ^{(k)}−α^{(k)}d^{(k)}≧σα^{(k)}(∇h(μ)^{T})d^{(k)} (20)

The pseudo-code of the algorithm is presented as follows:

A3: Pseudo-code to solve problem (17)

/* ε,σ,α₀ are positive constant values, ε is close to 0, and 0 < σ < 1 . */
1: Select a starting point μᵢ⁽⁰⁾ = 1 for all 1 ≦ i ≦ n.
2: Compute g(μ⁽⁰⁾), g̅⁽⁰⁾ and h(μ⁽⁰⁾) according to Equation (18).
3: Compute d⁽⁰⁾ according to Equation (19)
4: k = 0;
5: while ||g(μ^{(k)}) − g̅^{(k)} ||² ≧ ε do
6: /* Choose the step size */
7: α = α₀
8: while h(μ^{(k)}) − h(μ^{(k)} + α d^{(k)}) < σα · (∇h(μ)^{T})d^{(k)} do
9: α = α · β
10: end while
11: μ^{(k+1)} = μ^{(k)} + α · d^{(k)}
12: k = k + 1
13: Re-compute d(μ^{(k)}), g(μ^{(k)}), g̅^{(k)} and h(μ^{(k)})
14: end while

Lemma 5 Algorithm A3 converges to a stationary point of the function h(μ) (defined in Equation (18) assuming σ<1 and the finite stopping condition in the outer-loop is removed.

In general, the stationary point of a function h(μ) is not necessarily a global minimum of the function because of the non-convexity of the function. But, surprisingly, we can also prove that the limit point of the algorithm A3 is a global minimum (i.e., 0) of the function h(μ), which is also the unique solution to problems (16) and (17), even though the function h(μ) may not be convex. The result is stated in the following theorem and the proof is given hereinafter.

Theorem 3 Algorithm A3 converges to the optimum solution to the problems (16) and (17) assuming that the finite stopping condition in the outer-loop is removed.

The second enhancement of this dynamic scheduling scheme is on the frame dropping strategy. Note that the algorithm A3 not only produces the new vector μ that is used for user scheduling, but also the value

$$η = max {min}_{i = 1 }^{n} \frac{{r}_{i}}{{\overline{r}}_{i}} .$$

If η>1, then it indicates that the target rate vector r̅=( r̅₁, r̅₂, . . . , r̅ₙ) is achievable in the long term. If η<1, then it indicates that the target rate vector r̅ is un-achievable and some video frames need to be dropped. To overcome the short-term uncertainty of wireless channels, in this dynamic scheduling scheme, we maintain a target range (η, η̅) of η. During the periodic re-evaluation of the vector μ and η, if η< η̅, we will start to drop packets, and if η> η̅, we will put some dropped packets (whose playout deadline is not passed yet) back to the queue. To support the function of putting dropped packets back to the queue, we do not really drop a packet unless its playout deadline is passed. Instead, we simply mark it to be dropped.

When we need to drop some packets (i.e., η<η) or need to put some dropped packets back to the queue (i.e., η> η̅), we first choose the user using round robin. After the user is selected, we choose the packets that have the lowest priority within a window from now when dropping packets, and choose the packets that have the highest priority among those marked as dropped when putting dropped packets back to the queue. Then we re-compute the vector μ and η using Algorithm A3 and repeat the process until the value η falls between η and η̅. We use the final result μ for subsequent user scheduling.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A method, comprising:
building a model relating to a relationship between an average data rate and an average peak signal-to-noise ratio for a video sequence encoded using scalable video coding and having a base layer and one or more enhancement layers;
computing a vector relating to a set of average data rates for a particular boundary point on an achievable rate region for a transmission strategy, the boundary point being a function of a parameter set for a plurality of users, the achievable rate region based upon the model; and
scheduling the plurality of users to receive the video sequence over a wireless channel, such that at a given transmission time slot a particular one of the plurality of users associated with a maximum value is selected, the maximum value based on the vector and a channel capacity available to the particular one of the plurality of users.

2. The method of claim 1, wherein said step of building the model comprises:
determining a respective priority for each of the base layer and the one or more enhancement layers; and
adding each of the base layer and the one or more enhancement layers to the model in priority order to obtain a set of average rate and peak signal-to-noise pairs for different versions of the video sequence.

3. The method of claim 2, wherein said determining step determines the respective priority, for each respective one of the base layer and the one or more enhancement layers, based upon a ratio of a peak signal-to-noise ratio improvement with respect to a rate increase if the respective one of the base layer and the one or more enhancement layers is added to the video sequence.

4. The method of claim 2, wherein at least some of the different versions are based on truncating one of more of the base layer and the one or more enhancement layers.

5. The method of claim 2, wherein different values for the average rate are obtained for the model by truncating one or more frames in one or more of the base layer and the one or more enhancement layers.

6. The method of claim 5, wherein a layer truncation order from among the base layer and the one or more enhancement layers is determined based upon the respective priority of the base layer and the one or more enhancement layers.

7. The method of claim 1, wherein the vector is periodically updated based on at least one of a burstiness and a deadline of frames in the base layer and the one or more enhancement layers, and said scheduling step utilizes the updated vector to schedule the plurality of users.

8. The method of claim 1, wherein frames of the base layer and the one or more enhancement layers are selected for the particular one of the plurality of users in order of a respective decoding deadline for the frames, wherein any of the frames with a highest priority are chosen when two or more of the frames have a same decoding deadline.

9. The method of claim 8, further comprising:
utilizing an early dropping strategy on the frames for the particular one of the plurality of users, wherein said utilizing step comprises:
determining a minimum priority based on achievable rates for all of the plurality of users, such that an average data rate of the frames with a higher priority than or equal to the minimum priority does not exceed the achievable rates.

10. The method of claim 8, wherein the respective decoding deadline for a given frame is based upon a minimum playout deadline of all frames whose decoding depends upon the decoding of the given frame.

11. An apparatus, comprising:
a model builder for building a model relating to a relationship between an average data rate and an average peak signal-to-noise ratio for a video sequence encoded using scalable video coding and having a base layer and one or more enhancement layers; and
a user scheduler for computing a vector relating to a set of average data rates for a particular boundary point on an achievable rate region for a transmission strategy, the boundary point being a function of a parameter set for a plurality of users, the achievable rate region based upon the model,
wherein said user scheduler schedules the plurality of users to receive the video sequence over a wireless channel, such that at a given transmission time slot a particular one of the plurality of users associated with a maximum value is selected, the maximum value based on the vector and a channel capacity available to the particular one of the plurality of users.

12. The apparatus of claim 11, wherein said model builder builds the model by determining a respective priority for each of the base layer and the one or more enhancement layers, and adding each of the base layer and the one or more enhancement layers to the model in priority order to obtain a set of average rate and peak signal-to-noise pairs for different versions of the video sequence.

13. The apparatus of claim 12, wherein the respective priority, for each respective one of the base layer and the one or more enhancement layers, is determined based upon a ratio of a peak signal-to-noise ratio improvement with respect to a rate increase if the respective one of the base layer and the one or more enhancement layers is added to the video sequence.

14. The apparatus of claim 12, wherein at least some of the different versions are based on truncating one of more of the base layer and the one or more enhancement layers.

15. The apparatus of claim 12, wherein different values for the average rate are obtained for the model by truncating one or more frames in one or more of the base layer and the one or more enhancement layers.

16. The apparatus of claim 15, wherein a layer truncation order from among the base layer and the one or more enhancement layers is determined based upon the respective priority of the base layer and the one or more enhancement layers.

17. The apparatus of claim 11, wherein the vector is periodically updated based on at least one of a burstiness and a deadline of frames in the base layer and the one or more enhancement layers, and said user scheduler utilizes the updated vector to schedule the plurality of users.

18. The apparatus of claim 11, further comprising a frame scheduler for selecting, for transmission, frames of the base layer and the one or more enhancement layers for the particular one of the plurality of users in order of a respective decoding deadline for the frames, wherein any of the frames with a highest priority are chosen when two or more of the frames have a same decoding deadline.

19. The apparatus of claim 18, further comprising a frame dropper for utilizing an early dropping strategy on the frames for the particular one of the plurality of users, wherein the early dropping strategy involves determining a minimum priority based on achievable rates for all of the plurality of users, such that an average data rate of the frames with a higher priority than or equal to the minimum priority does not exceed the achievable rates.

20. The apparatus of claim 18, wherein the respective decoding deadline for a given frame is based upon a minimum playout deadline of all frames whose decoding depends upon the decoding of the given frame.
